(19) United States
(12) Patent Application Publication
(10) Pub. No.: US 2020/0021511 A1
(43) Pub. Date: Jan. 16, 2020

(54) PERFORMANCE ANALYSIS FOR TRANSPORT NETWORKS USING FREQUENT LOG SEQUENCE DISCOVERY

(71) Applicant: Fujitsu Limited, Kanagawa (JP)

(72) Inventors: Yunhong Xu, College Station, TX (US); Calvin Wan, Plano, TX (US); Maxwell Dalton Simmons, Newport Beach, CA (US); Chia-Hua Kuo, Houston, TX (US)

(73) Assignee: Fujitsu Limited, Kanagawa (JP)

(21) Appl. No.: 16/034,055

(22) Filed: Jul. 12, 2018

(51) Int. Cl. H04L 12/26; G06F 17/30

(52) U.S. Cl. CPC H04L 43/50; G06F 17/30197; G06F 17/30091; H04L 43/08

(57) ABSTRACT

Systems and methods for analyzing performance in a transport network may identify, in a log file, multiple log template types, each type including a respective fixed element present in all entries of that type, and create a data structure representing a finite state automaton in which each node represents the writing of log entries of a respective type into the log file. The order of nodes may correspond to the order in which the log entries were written, and each edge may connect nodes representing sequentially written entries. The systems and methods may remove nodes for which the indegree is less than a minimum indegree, identify, based on the pruned data structure, a repeated pattern in the log file including an ordered sequence of log entries of particular types, detect a deviation from the repeated pattern, and identify, based on detecting the deviation, an anomaly in the transport network.

### BACKGROUND

### Field of the Disclosure

The present disclosure relates to communication networks, and more specifically, to performance analysis for transport networks using frequent log sequence discovery.

### Description of the Related Art

A communication network may include network elements that route packets through the network. Some network elements may include a distributed architecture, wherein packet processing may be distributed among several subsystems of the network element (e.g., line cards). Thus, network elements may be modular and may include various sub-systems and sub-elements, which may include a shelf, a slot, a port, a channel, or various combinations thereof.

In particular, a network element can be abstracted as a generalized network node having ports that provide input and output paths to other ports on other nodes. Any communications network can, in turn, be represented using the node/port abstraction to make the large number of ports in the network visible.

Particular types of network elements routinely generate large numbers of log entries in various log files, including status logs, error logs, or other types of logs. Existing systems typically use a manual process to analyze the contents of entries in the log files in order to detect errors. For example, the log files may be accessed by a network administrator charged with analyzing the contents of the log files. In some cases, because these log files can include very large numbers of log entries, including log entries of different types, it can be difficult to distinguish normal behavior in the network from abnormal behavior based on the contents of the entries in the log files.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of a transport network;

FIG. 2 is a block diagram of selected elements of an embodiment of a network element;

FIG. 3 is a block diagram of selected elements of a network management system; and

FIG. 4 is a block diagram of selected elements of an embodiment of a method for performance analysis for transport networks using frequent log sequence discovery;

FIG. 5 is a block diagram of selected elements of an embodiment of a method for pruning an FSA and identifying repeated patterns of log entry template types;

FIGS. 6A-6F are block diagrams illustrating selected elements of a directed graph representation of an FSA created from a log file, according to one embodiment; and

FIG. 7 is a block diagram of selected elements of an embodiment of a method for using the performance analysis techniques described herein in a transport network.

### SUMMARY

In one aspect, a method for analyzing performance in a transport network is disclosed. The method may include identifying, in a log file into which log entries are written by one or more programs executing on network elements in the transport network, a plurality of log template types, each log template type including a respective fixed element present in all log entries of the log template type and creating a data structure representing a finite state automaton in which each node in the data structure represents the writing of one or more log entries of a respective log template type into the log file by the one or more programs, the order of the nodes in the data structure corresponding to the order in which the log entries were written by instructions executed on one or more execution paths of the one or more programs, and in which each edge in the data structure connects nodes representing sequentially written log entries. The method may also include pruning the data structure, the pruning including removing nodes for which the indegree is less than a predefined minimum indegree, identifying, based on the pruned data structure, a repeated pattern in the log file including an ordered sequence of two or more log entries of particular log template types, the pattern being repeated at least a predefined number of times in the log file, detecting, subsequent to identifying the repeated pattern, a deviation from the repeated pattern, and identifying, based on detecting the deviation from the repeated pattern, an anomaly in the transport network.

In any of the disclosed embodiments, detecting the deviation from the repeated pattern may include detecting, in the log file or in another log file into which log entries are written by programs executing on network elements in the transport network, that one of the two or more log entries of the particular log template types in the repeated pattern is missing in an ordered sequence of log entries that includes other ones of the log entries of the particular log template types in the repeated pattern.

In any of the disclosed embodiments, each log entry in the log file may include a respective timestamp indicating a time at which the log entry was written into the log file. The method may further include determining, based on the respective timestamps of the log entries in the log file, a respective amount of time that elapsed between writing successive ones of the log entries in the ordered sequence into the log file when the pattern was written into the log file at least the predefined number of times, and detecting the deviation from the repeated pattern may include detecting, in the log file or in another log file into which log entries are written by programs executing on network elements in the transport network subsequent to identifying the repeated pattern, that an amount of time that elapsed between writing two successive ones of the log entries in the ordered sequence into the log file or the other log file is different from the respective amount of time between writing the two successive ones of the log entries in the ordered sequence into the log file when the pattern was written into the log file at least the predefined number of times.

In any of the disclosed embodiments, the method may further include generating an indication of the identified anomaly in the transport network.

In any of the disclosed embodiments, the method may further include taking corrective action to mitigate the identified anomaly in in the transport network.

In any of the disclosed embodiments, the identified anomaly in the transport network may include a performance degradation of a network element in the transport network, a performance degradation of a link between network elements in the transport network, an error on a network element in the transport network, an error on a link between network elements in the transport network, a failure of a network element in the transport network, or a failure of a link between network elements in the transport network.

In any of the disclosed embodiments, the pruning may further include identifying multiple paths between nodes in the data structure representing the writing of log entries of a first log template type and nodes in the data structure representing the writing of log entries of a second log template type, each of the multiple paths corresponding to a respective execution path of the one or more programs, and calculating a frequency of transitions, in the identified multiple paths, from nodes in the data structure representing the writing of log entries of the first log template type and nodes in the data structure representing the writing of log entries of the second log template type.

In any of the disclosed embodiments, identifying, based on the pruned data structure, the repeated pattern in the log file may include identifying a group of sequentially ordered nodes for which the calculated frequency of transitions between each pair of nodes in the group of sequentially ordered nodes exceeds a predefined minimum number of transitions.

In any of the disclosed embodiments, the log file may include log entries written into the log file by two or more programs executing on network elements in the transport network, log entries written into the log file by multiple execution paths of a single program executing on a network element in the transport network, or log entries written into the log file by a single program executing on a network element in the transport network.

In any of the disclosed embodiments, for each log template type, the respective fixed element present in all log entries of the log template type may include an identifier of a hardware or software entity on whose behalf the log entry was written into the log file.

In another aspect, a system for analyzing performance in a transport network is disclosed. The system may include a processor configured to access non-transitory computer readable memory media storing instructions executable by the processor for identifying, in a log file into which log entries are written by one or more programs executing on network elements in the transport network, a plurality of log template types, each log template type including a respective fixed element present in all log entries of the log template type, and creating a data structure representing a finite state automaton in which each node in the data structure represents the writing of one or more log entries of a respective log template type into the log file by the one or more programs, the order of the nodes in the data structure corresponding to the order in which the log entries were written by instructions executed on one or more execution paths of the one or more programs, and in which each edge in the data structure connects nodes representing sequentially written log entries. The instructions may be further executable by the processor for pruning the data structure, the pruning including removing nodes for which the indegree is less than a predefined minimum indegree, identifying, based on the pruned data structure, a repeated pattern in the log file including an ordered sequence of two or more log entries of particular log template types, the pattern being repeated at least a predefined number of times in the log file, detecting, subsequent to identifying the repeated pattern, a deviation from the repeated pattern, and identifying, based on detecting the deviation from the repeated pattern, an anomaly in the transport network.

In any of the disclosed embodiments, detecting the deviation from the repeated pattern may include detecting, in the log file or in another log file into which log entries are written by programs executing on network elements in the transport network, that one of the two or more log entries of the particular log template types in the repeated pattern is missing in an ordered sequence of log entries that includes other ones of the log entries of the particular log template types in the repeated pattern.

In any of the disclosed embodiments, each log entry in the log file may include a respective timestamp indicating a time at which the log entry was written into the log file. The non-transitory computer readable memory media may further store instructions executable by the processor for determining, based on the respective timestamps of the log entries in the log file, a respective amount of time that elapsed between writing successive ones of the log entries in the ordered sequence into the log file when the pattern was written into the log file at least the predefined number of times, and detecting the deviation from the repeated pattern may include detecting, in the log file or in another log file into which log entries are written by programs executing on network elements in the transport network subsequent to identifying the repeated pattern, that an amount of time that elapsed between writing two successive ones of the log entries in the ordered sequence into the log file or the other log file is different from the respective amount of time between writing the two successive ones of the log entries in the ordered sequence into the log file when the pattern was written into the log file at least the predefined number of times.

In any of the disclosed embodiments, the non-transitory computer readable memory media may further store instructions executable by the processor for generating an indication of the identified anomaly in the transport network.

In any of the disclosed embodiments, the non-transitory computer readable memory media may further store instructions executable by the processor for taking corrective action to mitigate the identified anomaly in in the transport network.

In any of the disclosed embodiments, the identified anomaly in the transport network may include a performance degradation of a network element in the transport network, a performance degradation of a link between network elements in the transport network, an error on a network element in the transport network, an error on a link between network elements in the transport network, a failure of a network element in the transport network, or a failure of a link between network elements in the transport network.

In any of the disclosed embodiments, the pruning may further include identifying multiple paths between nodes in the data structure representing the writing of log entries of a first log template type and nodes in the data structure representing the writing of log entries of a second log template type, each of the multiple paths corresponding to a respective execution path of the one or more programs, and calculating a frequency of transitions, in the identified multiple paths, from nodes in the data structure representing the writing of log entries of the first log template type and nodes in the data structure representing the writing of log entries of the second log template type.

In any of the disclosed embodiments, identifying, based on the pruned data structure, the repeated pattern in the log file may include identifying a group of sequentially ordered nodes for which the calculated frequency of transitions between each pair of nodes in the group of sequentially ordered nodes exceeds a predefined minimum number of transitions.

In any of the disclosed embodiments, the log file may include log entries written into the log file by two or more programs executing on network elements in the transport network, log entries written into the log file by multiple execution paths of a single program executing on a network element in the transport network, or log entries written into the log file by a single program executing on a network element in the transport network.

In any of the disclosed embodiments, for each log template type, the respective fixed element present in all log entries of the log template type may include an identifier of a hardware or software entity on whose behalf the log entry was written into the log file.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective or generic element. Thus, for example, widget 12-1 refers to an instance of a widget class, which may be referred to collectively as widgets 12 and any one of which may be referred to generically as a widget 12.

As will be disclosed in further detail below, the systems described herein may use frequent log sequence discovery to inform performance analyses for transport networks. In at least some embodiments of the present disclosure, rather than searching the contents of the entries in a log file for keywords such as “alarm” or “error,” and then manually examining those log entries to detect anomalies, these systems may instead search for and identify sequences of log entries of particular log entry types without regard to the variable portions of their contents. For example, an application may include a particular print statement that is executed multiple times, but that may write different values to a log file at different times. This print statement may include one or more fixed elements (e.g., a collection of labels) which are potentially paired with different values each time the print statement is executed. In this example, each of the resulting log entries would be considered a log entry of the same type despite the variable portions of their contents being different. In at least some embodiments, the systems may use a minimum support threshold value to determine whether transitions between log entries of particular types are common enough in the log file to be considered for use in subsequent performance monitoring and analyses.

The techniques disclosed herein may be used to automatically and efficiently detect and identify frequent patterns of log entries of particular types in a log file while ignoring log entries or sequences of log entries of particular types that are less frequently written in the log file. The disclosed rule-based techniques for determining frequent patterns of log entries of particular log types and pruning less frequent patterns of log entries of particular log types may improve the accuracy of anomaly detection in the system when compared to a priori type algorithms that are based on analyses of individual log entries.

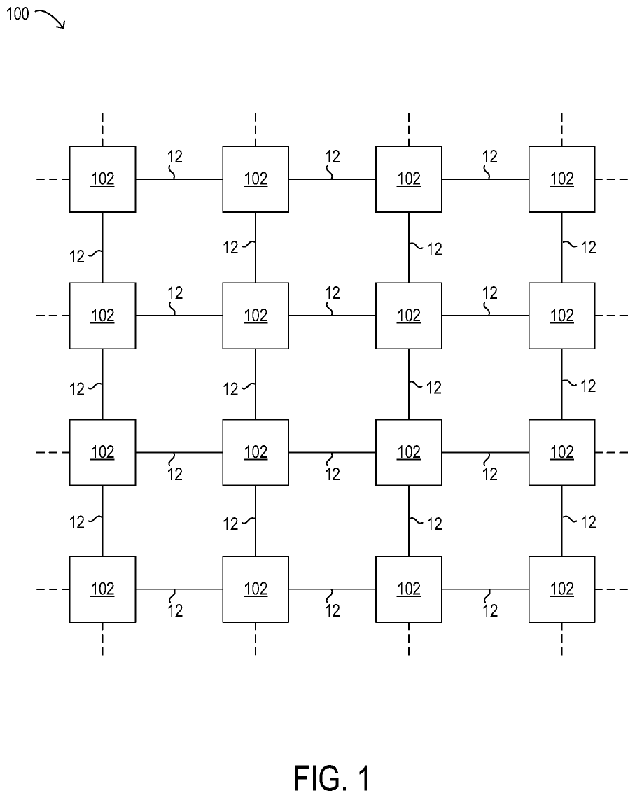

Turning now to the drawings, FIG. 1 is a block diagram showing selected elements of an embodiment of a transport network 100. In certain embodiments, network 100 may be an Ethernet network. Network 100 may include one or more transmission media 12 operable to transport one or more signals communicated by components of network 100. The components of network 100, coupled together by transmission media 12, may include a plurality of network elements 102. In the illustrated network 100, each network element 102 is coupled to four other network elements. However, any suitable configuration of any suitable number of network elements 102 may create network 100. Although network 100 is shown as a mesh network, network 100 may also be configured as a ring network, a point-to-point network, or any other suitable network or combination of networks. Network 100 may be used in a short-haul metropolitan network, a long-haul inter-city network, or any other suitable network or combination of networks.

Each transmission medium 12 may include any system, device, or apparatus configured to communicatively couple network devices 102 to each other and communicate information between corresponding network devices 102. For example, a transmission medium 12 may include an optical fiber, an Ethernet cable, a T1 cable, a WiFi signal, a Bluetooth signal, or other suitable medium.

Network 100 may communicate information or “traffic” over transmission media 12. As used herein, “traffic” means information transmitted, stored, or sorted in network 100. Such traffic may comprise optical or electrical signals configured to encode audio, video, textual, and/or any other suitable data. The data may also be transmitted in a synchronous or asynchronous manner and may be transmitted deterministically (also referred to as ‘real-time’) and/or stochastically. Traffic may be communicated via any suitable communications protocol, including, without limitation, the Open Systems Interconnection (OSI) standard and Internet Protocol (IP). Additionally, the traffic communicated via network 100 may be structured in any appropriate manner including, but not limited to, being structured in frames, packets, or an unstructured bit stream.

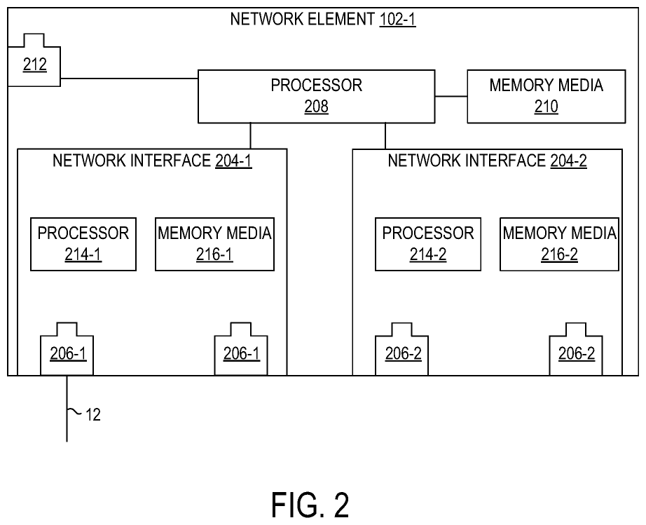

Each network element 102 in network 100 may comprise any suitable system operable to transmit and receive traffic. In the illustrated embodiment, each network element 102 may be operable to transmit traffic directly to one or more other network elements 102 and receive traffic directly from the one or more other network elements 102. Network elements 102 will be discussed in more detail below with respect to FIG. 2.

Modifications, additions, or omissions may be made to network 100 without departing from the scope of the disclosure. The components and elements of network 100 described may be integrated or separated according to particular needs. Moreover, the operations of network 100 may be performed by more, fewer, or other components.

In operation, as will be described in further detail herein, applications operating on any one or more of network elements 102 may generate log entries of various types that are written to one or more log files on network elements in network 100. In some embodiments, frequent log sequence discovery, as described herein, may be used for performance analyses for network 100.

Referring now to FIG. 2, a block diagram of selected elements of an embodiment of network element 102-1, which is represented as a particular embodiment of network elements 102 for descriptive purposes, is illustrated. Network element 102-1, as shown, includes processor 208 and memory media 210, and external port 212, along with network interface 204-1 having ports 206-1 and network interface 204-2 having ports 206-2. External port 212 may be used by processor 208 to communicate with neighbor network elements (see FIG. 1).

As depicted in FIG. 2, each network element 102 may include processor 208 and memory media 210 that may store instructions executable by processor 208. Processor 208 may include a single processing unit (e.g., a core) or may include multiple processing units (not shown). In certain embodiments, processor 208 may represent a multi-processor subsystem in which each individual processor includes one or more processing units. The individual processors or processing units may provide processing resources, such as a processing frequency, messaging, instruction queuing, memory caching, virtual memory, among others, to process instructions and code. As shown, memory media 210 may represent volatile, non-volatile, fixed, or removable media, and may be implemented using magnetic or semiconductor memory. Memory media 210 is capable of storing instructions (i.e., code executable by processor 208) and data. Memory media 210, or at least a portion of contents of memory media 210, may be implemented as an article of manufacture comprising non-transitory computer readable memory media storing processor-executable instructions. Memory media 210 may store instructions including an operating system (OS), which may be any of a variety of operating systems, such as a UNIX variant, LINUX, a Microsoft Windows® operating system, or a different operating system. In various embodiments, each network element 102 may represent a network node at which one or more physical computing devices, such as client computing devices or servers, reside. Any of a variety of applications may be implemented by program instructions executing on the physical computing devices residing at particular ones of the network nodes, in different embodiments.

In FIG. 2, network elements 102 are shown including at least one network interface 204, which provides a plurality of ports 206 that receive a corresponding transmission media 12 (see also FIG. 1). Ports 206 and transmission media 12 may represent galvanic or optical network connections. Each network interface 204 may include any suitable system, apparatus, or device configured to serve as an interface between a network element 102 and transmission medium 12. Each network interface 204 may enable its associated network element 102 to communicate with other network elements 102 using any of a variety of transmission protocols and standards. Network interface 204 and its various components may be implemented using hardware, software, or any combination thereof. In certain embodiments, network interfaces 204 may include a network interface card. In various embodiments, network interfaces 204 may include a line card. Each port 206 may include a system, device or apparatus configured to serve as a physical interface between corresponding transmission medium 12 and network interface 204. In some embodiments, port 206 may comprise an Ethernet port. Although in FIG. 2 network interfaces 204 are shown with 2 instances of ports 206 for descriptive clarity, in different embodiments, network interfaces 204 may be equipped with different numbers of ports 206 (e.g., 4, 6, 8, 16 ports, etc.).

As shown in FIG. 2, network interfaces 204 may include respective processors 214 and memory media 216, which may store and execute instructions and may be implemented in a similar manner as described above with respect to processor 208 and memory media 210, respectively. In various embodiments, processors 214 may execute internal instructions and operations, such as for packet routing and forwarding, and may be under control or supervision of processor 208. Furthermore, processor 208 and processor(s) 214, along with various internal and external network ports included in network element 102, may represent at least one local domain that is configured at network element 102. In some embodiments, the local domains include at least one virtual local area network (VLAN) domain.

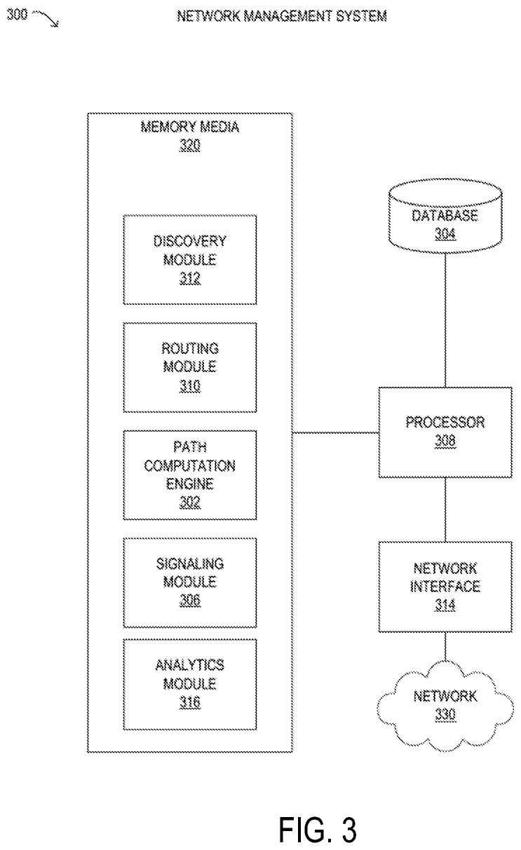

In various embodiments, log entries may be written into one or more log files by program instructions in memory media 210 executed by processor 208 or by program instructions in one of memory media instances 216 executed by a corresponding processor 214. The log files may reside locally within memory media 210 or any of memory media instances 216 or may reside at a central location within the network (see, e.g., database 304 in FIG. 3). In some embodiments, the techniques described herein for performance analysis for transport networks using frequent log sequence discovery may be implemented by program instructions in memory media 210 executed by processor 208 or by program instructions in one of memory media instances 216 executed by a corresponding processor 214.

In various embodiments, network element 102 may be configured to receive data and route such data to a particular network interface 204 and port 206 based on analyzing the contents of the data or based on a characteristic of a signal carrying the data (e.g., a wavelength or modulation of the signal). In certain embodiments, network element 102 may include a switching element (not shown) that may include a switch fabric (SWF).

Referring now to FIG. 3, a block diagram of selected elements of an embodiment of network management system 300 for implementing control plane functionality in optical networks, such as, for example, in optical transport network 100 (see FIG. 1), is illustrated. A control plane may include functionality for network intelligence and control and may comprise applications that support the ability to establish network services, including applications or modules for discovery, routing, path computation, and signaling, as will be described in further detail. The control plane applications executed by network management system 300 may work together to automatically establish services within the optical network. Discovery module 312 may discover local links connecting to neighbors. Routing module 310 may broadcast local link information to optical network nodes while populating database 304. When a request for service from the optical network is received, path computation engine 302 may be called to compute a network path using database 304. This network path may then be provided to signaling module 306 to establish the requested service. An analytics module 316 may perform various analyses on network data, such as network data collected by the control plane and stored using database 304, among other network data.

In some embodiments, log files written to by various applications operating on network element 102 in network 100 may reside in database 304. For example, log entries may be written directly to a central log file during operation of network 100 or may be written to log files stored locally on various network elements during operation of network 100 and then transferred to database 304 for aggregation and/or analysis. In some embodiments, repeated patterns of log entries of particular log template types that are identified using the techniques described herein may be stored in database 304. In other embodiments, the repeated patterns of log entries of particular log template types that are identified using the techniques described herein may be stored locally on one or more network elements (e.g., in memory media 210 or instances of memory media 216).

As shown in FIG. 3, network management system 300 includes processor 308 and memory media 320, which may store executable instructions (i.e., executable code) that may be executable by processor 308, which has access to memory media 320. Processor 308 may execute instructions that cause network management system 300 to perform the functions and operations described herein. For the purposes of this disclosure, memory media 320 may include non-transitory computer-readable media that stores data and instructions for at least a period of time. Memory media 320 may comprise persistent and volatile media, fixed and removable media, and magnetic and semiconductor media. Memory media 320 may include, without limitation, storage media such as a direct access storage device (e.g., a hard disk drive or floppy disk), a sequential access storage device (e.g., a tape disk drive), compact disk (CD), random access memory (RAM), read-only memory (ROM), CD-ROM, digital versatile disc (DVD), electrically erasable programmable read-only memory (EEPROM), and flash memory; non-transitory media, or various combinations of the foregoing. Memory media 320 is operable to store instructions, data, or both. Memory media 320 as shown includes sets or sequences of instructions that may represent executable computer programs, namely, path computation engine 302, signaling module 306, discovery module 312, routing module 310, and analytics module 316. In some embodiments, analytics module 316, in conjunction with path computation engine 302, signaling module 306, discovery module 312, and routing module 310, may represent instructions or code for implementing various algorithms according to the present disclosure.

Also shown included with network management system 300 in FIG. 3 is network interface 314, which may be a suitable system, apparatus, or device operable to serve as an interface between processor 308 and network 330. Network interface 314 may enable network management system 300 to communicate over network 330 using a suitable transmission protocol or standard. In some embodiments, network interface 314 may be communicatively coupled via network 330 to a network storage resource. In some embodiments, network 330 represents at least certain portions of network 100. In certain embodiments, network 330 may include at least certain portions of a public network, such as the Internet. Network 330 may be implemented using hardware, software, or various combinations thereof.

In certain embodiments, the control plane may be configured to interface with a person (i.e., a user) and receive data about the signal transmission path. For example, the control plane may also include and/or may be coupled to one or more input devices or output devices to facilitate receiving data about the signal transmission path from the user and outputting results to the user. The one or more input and output devices (not shown) may include, but are not limited to, a keyboard, a mouse, a touchpad, a microphone, a display, a touchscreen display, an audio speaker, or the like. Alternately or additionally, the control plane may be configured to receive data about the signal transmission path from a device such as another computing device or a network element (not shown in FIG. 3).

As shown in FIG. 3, in some embodiments, discovery module 312 may be configured to receive data concerning a signal transmission path in a network and may be responsible for discovery of neighbors and links between neighbors. In other words, discovery module 312 may send discovery messages according to a discovery protocol, and may receive data about the signal transmission path. In some embodiments, discovery module 312 may determine features, such as, but not limited to, media type; media length; number and type of components; data rate; modulation format of the data; input power of an optical signal; number of optical signal carrying wavelengths (i.e., channels); channel spacing; traffic demand; and network topology, among others.

As shown in FIG. 3, routing module 310 may be responsible for propagating link connectivity information to various nodes within a network, such as network 100. In particular embodiments, routing module 310 may populate database 304 with resource information to support traffic engineering, which may include link bandwidth availability. Accordingly, database 304 may be populated by routing module 310 with information usable to determine a network topology of a network.

Path computation engine 302 may be configured to use the information provided by routing module 310 to database 304 to determine transmission characteristics of the signal transmission path. The transmission characteristics of the signal transmission path may provide insight on how transmission degradation factors may affect the signal transmission path. When the network is an optical network, the transmission degradation factors may include, for example: chromatic dispersion (CD), nonlinear (NL) effects, polarization effects, such as polarization mode dispersion (PMD) and polarization dependent loss (PDL), amplified spontaneous emission (ASE) and/or others, which may affect optical signals within an optical signal transmission path. To determine the transmission characteristics of the signal transmission path, path computation engine 302 may consider the interplay between various transmission degradation factors. In various embodiments, path computation engine 302 may generate values for specific transmission degradation factors. Path computation engine 302 may further store data describing the signal transmission path in database 304.

In FIG. 3, signaling module 306 may provide functionality associated with setting up, modifying, and tearing down end-to-end networks services in network 100. For example, when an ingress node in the optical network receives a service request, the control plane may employ signaling module 306 to request a network path from path computation engine 302 that may be optimized according to different criteria, such as bandwidth, cost, etc. When the desired network path is identified, signaling module 306 may then communicate with respective nodes along the network path to establish the requested network services. In different embodiments, signaling module 306 may employ a signaling protocol to propagate subsequent communication to and from nodes along the network path.

In FIG. 3, analytics module 316 may provide functionality to access various network information and to execute analytical algorithms for various purposes and directed to different stakeholders. For example, in some embodiments, the techniques described herein for performance analysis for transport networks using frequent log sequence discovery may be implemented by analytics module 316. This may include extracting log templates from one or more log files, identifying repeated patterns of log entries of particular log template types in the log files, detecting deviations from the repeated patterns, identifying anomalies in the network based on the detected deviations from the repeated patterns, generating an indication of any deviations from the repeated pattern or identified anomalies, and/or taking (or initiating the taking of) one or more corrective actions to mitigate any identified anomalies. It is noted that in some embodiments, analytics module 316 may execute on a computer system represented by processor 308 and memory media 320 illustrated in FIG. 3. In some embodiments, computer system may execute analytics module 316 without executing any one or more of discovery module 312, routing module 310, path computation engine 302, and signaling module 316. In particular embodiments, analytics module 316 may be executed on a computer executing a software-defined networking (SDN) controller (not shown).

As previously noted, various applications operating on network elements in a transport network may generate large numbers of log file entries each day. Log entries may be generated and stored locally in a log file on a piece of network equipment or in a log file stored elsewhere on the system, such as on a shared disk. For example, various software programs, or specific routines thereof, may call standard or custom logging functions, print statements, or other suitable utility functions for writing out the state of the program at different points in time during execution of the program. In some cases, a log entry may include information related to the use of machine resources. The log entries may be written to shared log files or to log files specific to a particular program, piece of equipment, or computing resource. In some cases, each log entry may include a timestamp in addition to log data. A log entry might or might not include an identifier of any specific hardware elements associated with the log entry. Different log entries may be associate with different software components.

In some cases, log entries written by programs executing in a transport network may be used for software debugging and/or anomaly detection. For example, when a program is running normally, there may be a particular sequence of log entries written out to a log file that report the state or status of the program, or an associated device, at different points in time in accordance with the program flow. When a program is not running normally, log entries explicitly written out to the log file in response to the abnormal behavior may include error messages or warnings, some of which might not be indicative of an actual problem. Existing systems typically perform anomaly detection by analyzing individual log entries that include keywords such as “error” or “alarm”. This approach can be very time intensive and/or resource intensive and may be prone to generating false alarms or failing to detect real problems.

In some embodiments of the present disclosure, the log files (or log entries thereof) written by applications executing on network elements in a transport network may be communicated to other network elements using any suitable file transfer program where, in some cases, they may be aggregated prior to performing analyses for anomaly detection. In some embodiments of the present disclosure, the disclosed systems may be operable to automatically identify and extract log templates (e.g., from previously stored log files or from log files collected during a training phase in the transport network). Each log template may include a respective fixed element present in all log entries of the log template type. For example, in some embodiments, a given print statement associated with a particular log template type may write log entries to a log file that include a collection of labels (which are fixed elements) as well as one or more values (which are variable elements). In one example, in a print statement of the form:
print (lineNumber, “startLabel”, “label A”, valueA, “label B”, valueB, “endLabel”),
   the fixed elements include “startLabel”, “label A”, “label B”, and “endLabel”, and the variable elements include the values of the variables lineNumber, valueA, and valueB. Any log entry that includes these fixed elements, in the order and positions shown in this example, may be considered log entries of the same log template type. Multiple such log template types may be identified and extracted from the log file, each containing a respective collection of one or more fixed elements.

In some embodiments, the disclosed systems may be operable to build a data structure representing a finite state automaton (FSA) from the extracted log templates. The data structure representation may include multiple data structure paths on which nodes representing respective log template types (connected by edges) are present in the order in which log entries of the particular types are written out by program instructions on different execution paths of a single executing program or by multiple executing programs. One example method for identifying log template types is described in more detail below, according to some embodiments.

After creating the FSA data structure, the systems described herein may be operable to reduce the number of nodes and edges in the FSA by pruning less frequently repeated sequences of nodes and their corresponding edges and merging multiple edges that connect particular pairs of consecutive nodes. As described in more detail below, groups of nodes representing frequently repeated patterns of log entries of particular log template types may be identified based on the pruned FSA. Subsequently, the system may be operable to detect any deviations from an identified repeated pattern in a log file generated in the transport network, and to identify an anomaly in the transport network based on any detected deviations.

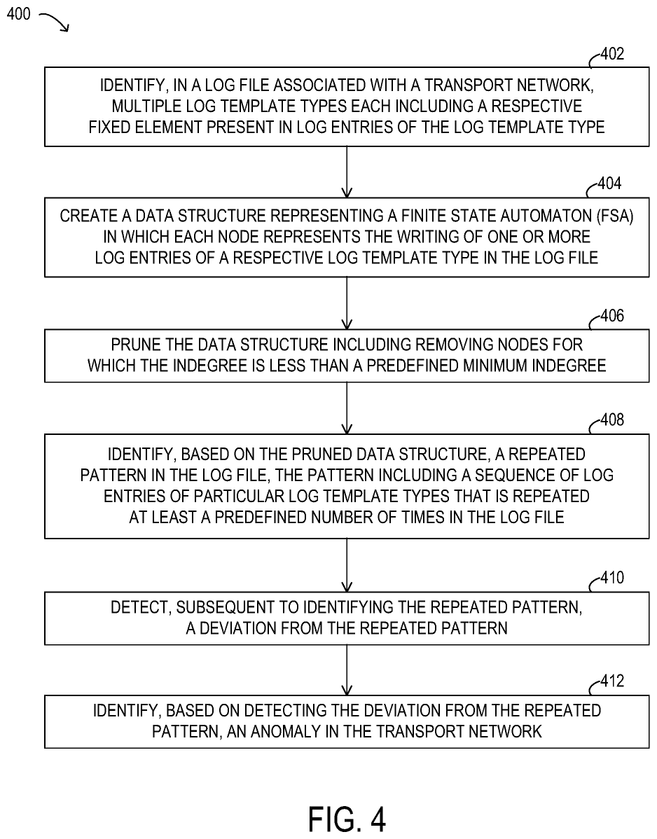

FIG. 4 is a block diagram of selected elements of an embodiment of a method 400 for performance analysis for transport networks using frequent log sequence discovery, as described herein. In some embodiments, method 400 may be performed using one or more network elements 102 (see FIGS. 1 and 2). For example, one or more operations of method 400 may be implemented by program instructions in memory media 210 executed by processor 208 or by program instructions in one of memory media instances 216 executed by a corresponding processor 214, in different embodiments. In some embodiments, one or more operations of method 400 may be executed by analytics module 316 (see FIG. 3). It is noted that certain operations described in method 400 may be optional or may be rearranged in different embodiments.

In the example embodiment illustrated in FIG. 4, method 400 begins at 402 by identifying, in a log file associated with a transport network, multiple log template types each including a respective fixed element present in all log entries of the log template type. An example method for identifying and extracting log templates from the log file is described below, according to some embodiments.

At 404, the method may include creating a data structure representing a finite state automaton (FSA) in which each node in the data structure represents the writing of one or more log entries of a respective log template type into the log file by programs executing in the transport network. The order of the nodes in the data structure may correspond to the order in which the log entries were written by instructions executed on one or more execution paths of the programs. Each edge in the data structure may connect nodes representing sequentially written log entries. The data structure may be implemented using any suitable data structure format or architecture including, but not limited to, a directed graph, a linked list, a relational database table, an associative memory structure, or another type of graph, list, or table.

At 406, method 400 may include pruning the data structure, which may include removing nodes for which the indegree is less than a predefined minimum indegree, where the “indegree” of a given node refers to the number of edges leading into the given node. As used herein, the term “minimum support threshold value” may refer to a predefined minimum indegree.

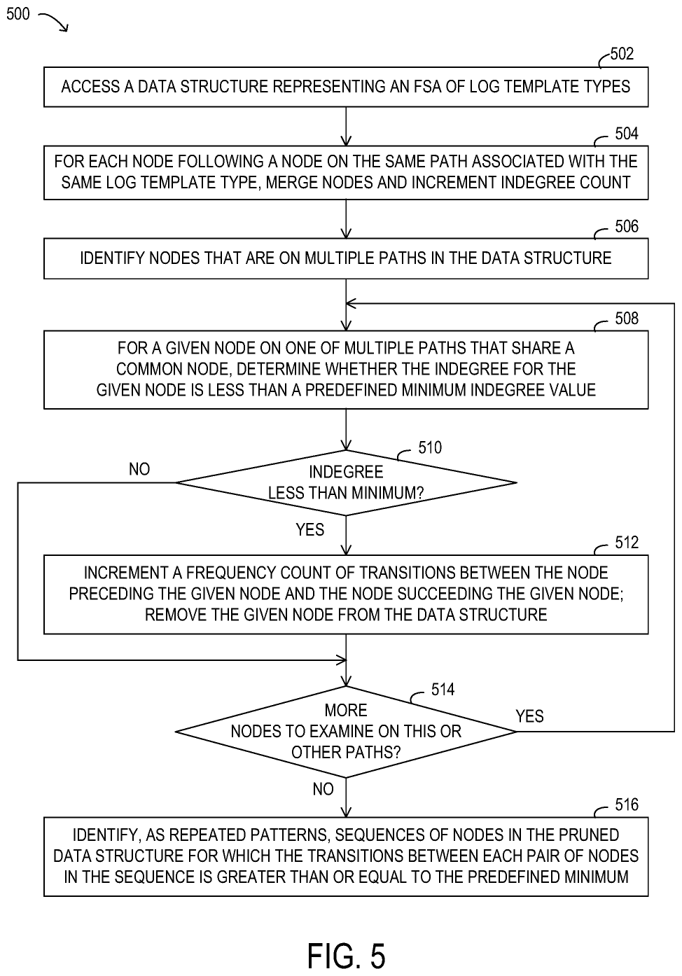

At 408, the method may include identifying, based on the pruned data structure, a repeated pattern in the log file. The pattern may include a sequence of log entries of particular log template types that is repeated at least a predefined number of times in the log file. In some embodiments, multiple repeated patterns may be identified in the log file, each of which appears at least the predefined number of times and each of which includes a different ordered sequence of log entries of particular types. An example method for pruning the data structure and identifying a repeated pattern in the log file is illustrated in FIG. 5 and described in detail below, according to some embodiments.

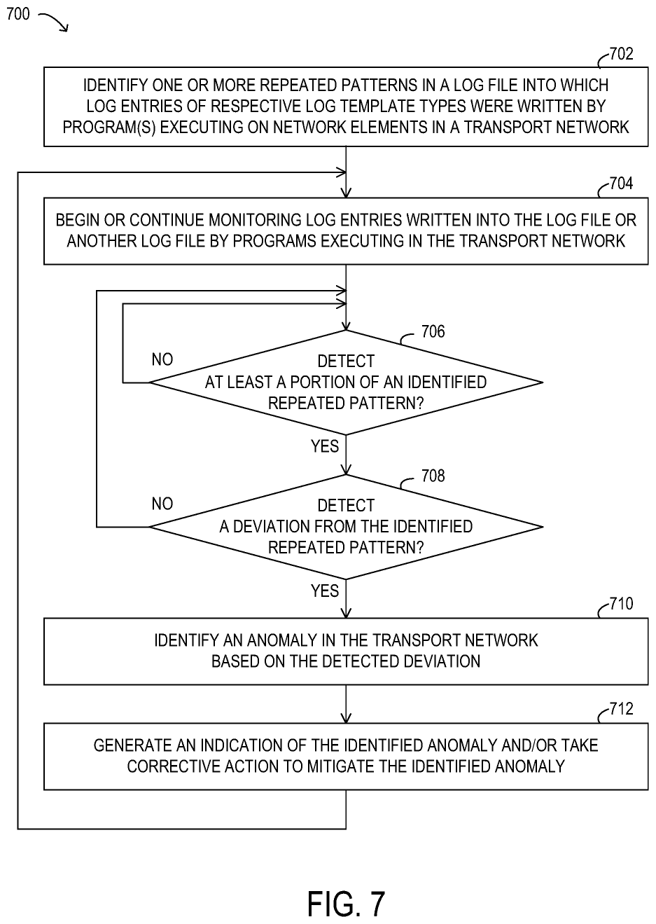

At 410, the method may include detecting, subsequent to identifying the repeated pattern, a deviation from the repeated pattern. As described in more detail below in reference to FIG. 7, in some embodiments the deviation may be manifested as missing state in the repeated pattern or as a change in the timing between two states in the repeated pattern.

At 412, the method may include identifying, based on detecting the deviation from the repeated pattern, an anomaly in the transport network. The identified anomaly in the transport network may include a performance degradation of a network element in the transport network, a performance degradation of a link between network elements in the transport network, an error on a network element in the transport network, an error on a link between network elements in the transport network, a failure of a network element in the transport network, or a failure of a link between network elements in the transport network. As described in more detail below in reference to FIG. 7, any of a variety of suitable actions may be taken in response to identifying an anomaly in the transport network, in different embodiments, some of which may mitigate the identified anomaly.

In some embodiments, the systems described herein may apply a data clustering algorithm to one or more log files to identify and extract log template types. For example, a data clustering algorithm may be used to eliminate the variable elements in each log entry, at which point all log entries written by the same log or print function may look the same. Once the variable elements are eliminated, each different ordered collection of fixed elements may define a respective log template type. In one data clustering algorithm, the elements in each of the log entries are separated into different columns in a table of log entries. Some columns will contain fixed elements that are included in all log entries of a particular log template type and other columns will contain variable elements. The data clustering algorithm may be operable to determine which elements are likely to be fixed elements and which elements are likely to be variable elements by analyzing the frequency with which particular elements and ordered collections of elements are present in the log entries.

In some embodiments, there are multiple levels at which log entries may be analyzed in a transport network in which multiple programs, or execution paths thereof, write log entries into respective log files. In some embodiments, after classifying each of the log entries as being associated with a particular log template type, the log entries may be filtered in different ways to focus subsequent log analyses, such as by program or by another type of hardware or software entity identifier. In one example, the analyses may be applied to log entries written to (or aggregated in) a single log file by multiple programs executing in parallel. In this example, all of the log entries in the single log file may be considered collectively when creating an FSA, pruning the FSA, and identifying repeated patterns of log entries of particular log template types. In another example, the analyses may be applied to log entries written to a single log file by instructions on one or more execution paths of a single program. In this example, only the log entries written to the log file by instructions on one or more execution paths of a single program may be considered when creating an FSA, pruning the FSA, and identifying repeated patterns of log entries of particular log template types.

In yet another example, the analyses may be applied only to log entries associated with a given hardware or software entity identifier, where the given hardware or software entity identifier is present in a subset of the log entries. In this example, only the log entries associated with the given hardware or software entity identifier may be considered when creating an FSA, pruning the FSA, and identifying repeated patterns of log entries of particular log template types. For example, in some embodiments, each network element in the transport network may be associated with a unique entity identifier, each computing device at each network element may be associated with a unique entity identifier, each cross connect (or link) in the transport network may be associated with a unique entity identifier, and/or each software application (or particular routines thereof) may be associated with a unique entity identifier, and the log analyses may be applied to particular subsets of the log entries based on the values of one or more of these identifiers. In some embodiments, performing the log analyses only on the subset of log entries associated with particular entity identifiers may provide more accurate anomaly detection than performing the log analyses at a higher level of abstraction. In general, the log file analyses described herein may be performed on any subset of log entries in a log file that are associated with a particular value (or collection or range of values) for any of the variable elements present in the log entries.

As previously noted, a data structure (e.g., a directed graph) representing an FSA created from extracted log template types (or a subset of identified log template types) may be pruned to remove nodes with an indegree that is less than a predefined minimum support threshold value. In some embodiments, pruning the FSA may include calculating a weight of the transitions between two nodes that indirectly follow each other by removing all the nodes between them and incrementing the weight by one for each node removed. The time complexity of this pruning approach is O(m), where m is the number edges between the two nodes. In some embodiments, pruning the FSA may include identifying multiple paths between nodes in the FSA representing the writing of log entries of a first log template type and nodes in the FSA representing the writing of log entries of a second log template type, and calculating a frequency of transitions, in the identified multiple paths, from nodes in the FSA representing the writing of log entries of the first log template type and nodes in the FSA representing the writing of log entries of the second log template type. In some embodiments, identifying a repeated pattern in the log file to be used in subsequent performance monitoring and analyses may include identifying a group of sequentially ordered nodes in the pruned FSA for which the calculated frequency of transitions between each pair of nodes in the group exceeds a predefined minimum number of transitions.

FIG. 5 is a block diagram of selected elements of an embodiment of a method 500 for pruning an FSA and identifying repeated patterns of log entry template types, as described herein. In some embodiments, method 500 may be performed using one or more network elements 102 (see FIGS. 1 and 2). For example, one or more operations of method 500 may be implemented by program instructions in memory media 210 executed by processor 208 or by program instructions in one of memory media instances 216 executed by a corresponding processor 214, in different embodiments. In some embodiments, one or more operations of method 500 may be executed by analytics module 316 (see FIG. 3). It is noted that certain operations described in method 500 may be optional or may be rearranged in different embodiments.

In the example embodiment illustrated in FIG. 5, method 500 begins at 502 by accessing a data structure representing an FSA of log template types. As described above, the order of the nodes in the data structure may correspond to the order in which log entries were written by instructions executed on one or more execution paths of programs executing on network elements in a transport network. Each edge in the data structure may connect nodes corresponding to log entries written sequentially by instructions on a particular execution path. Therefore, the paths between the nodes in the data structure, prior to pruning, may correspond to the execution paths of the executing programs, with the nodes arranged according to the program order of the instructions executed on the execution paths. For example, multiple paths in the data structure may represent different execution paths of a single program or execution paths of multiple programs executing in parallel on one or more network elements in the transport network.

At 504, method 500 may include, for each node in a single path of the data structure that follows a node on the same path associated with the same log template type, merging the two nodes into a single node in the data structure and incrementing an indegree count associated with the merged node to reflect the total number of consecutive nodes associated with the same log template type on that path. In this example embodiment, the nodes on a single path might not be pruned in the data structure, but consecutive nodes associated with the same log template type may be merged in the data structure, reducing the number of nodes.

At 506, method 500 may include identifying nodes that are on multiple paths in the data structure, after which a determination may be made about which, if any, of the identified nodes should be pruned from the data structure.

At 508, the method may include, for a given node on one of multiple paths that share a common node, other than the common node, determining whether the indegree for the given node is less than a predefined minimum indegree value.

If, at 510, it is determined that the indegree for the given node is less than the predefined minimum indegree value, method 500 may continue to 512. Otherwise method 500 may proceed to 514. At 512, the method may include incrementing a frequency count of transitions between the node preceding the given node and the node succeeding the given node, and removing the given node from the data structure. In this way, the data structure is pruned to remove infrequent sequences of log template types from consideration as repeated patterns to be used in subsequent performance monitoring and analyses.

If, at 514, it is determined that there are more nodes to examine on the current path or on other paths, method 500 may return to 508, after which the operations shown as 508-514 may be repeated, as appropriate, for one or more additional nodes on paths that include shared nodes.

If, or once, it is determined that there are no more nodes to examine on the current path or on other paths in the data structure, method 500 may proceed to 516.

At 516, the method may include identifying, as repeated patterns to be used in subsequent performance analyses, sequences of nodes in the pruned data structure for which the transitions between each pair of nodes in the sequence is greater than or equal to the predefined minimum indegree value.

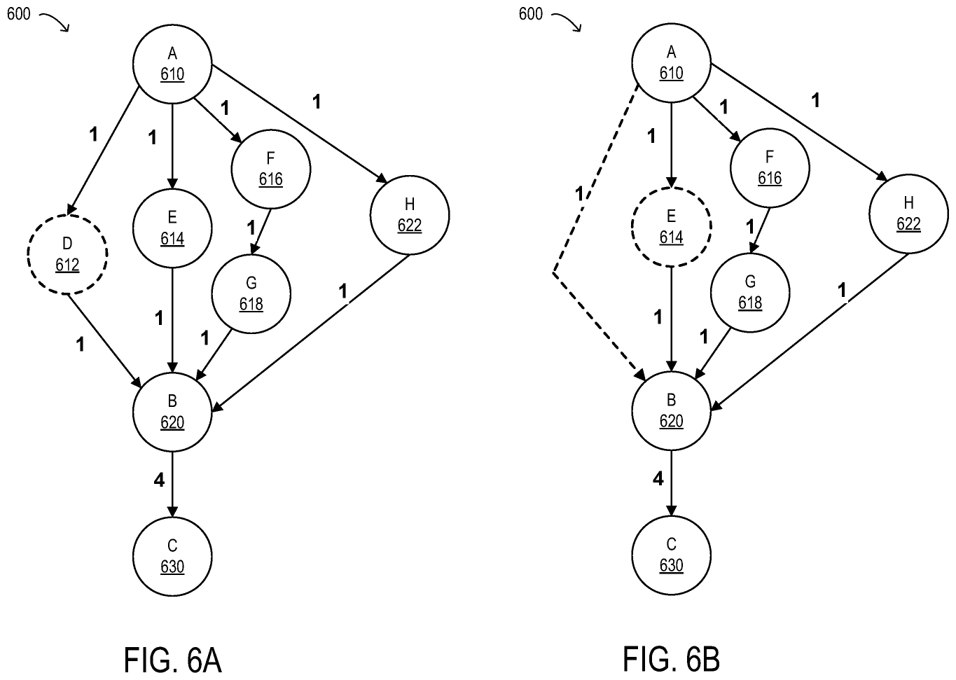

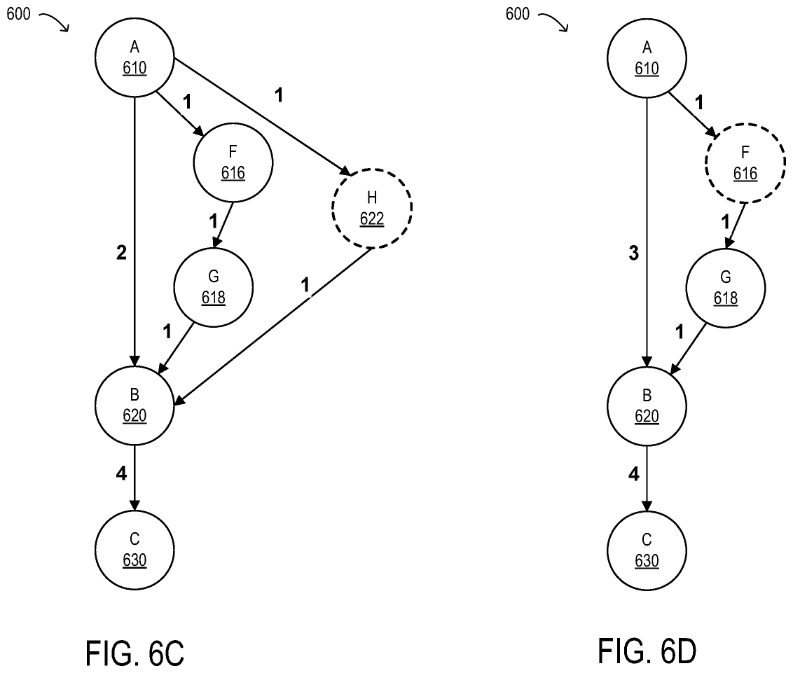

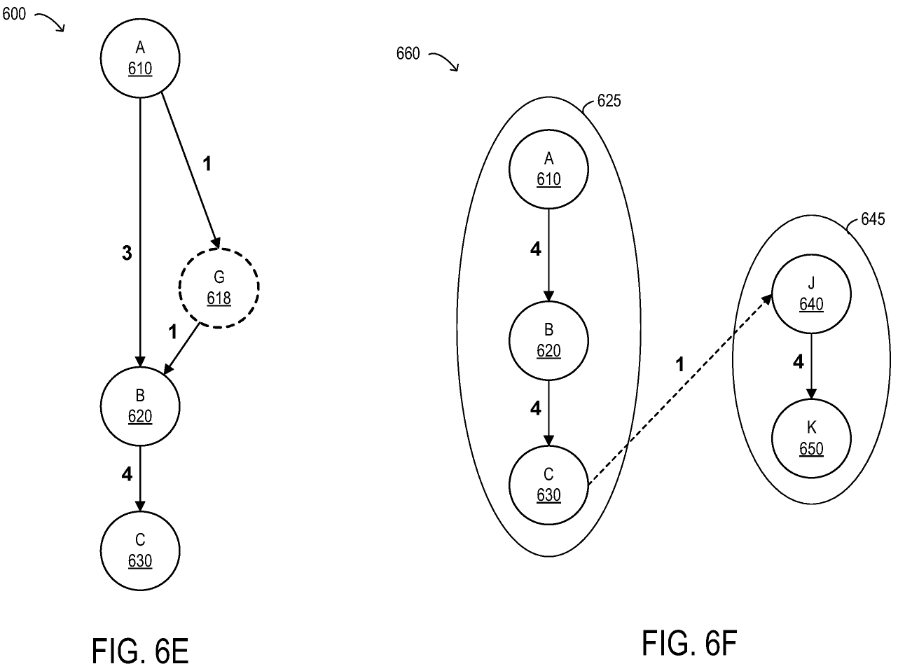

FIGS. 6A-6F are block diagrams illustrating selected elements of a directed graph representation of an FSA created from a log file, according to one embodiment. More specifically, FIGS. 6A through 6F illustrate the results of selected actions taken during an operation to prune the FSA, where the minimum support threshold value is four. In the illustrated example, each circle in FSA 600 is a node that represents the writing of one or more log entries of a respective log template type into a log file. The order of the nodes corresponds to the order in which the log entries into the log file. Each edge in FSA 600 connects nodes representing sequentially written log entries. For example, FIG. 6A illustrates a portion of FSA 600 in which a node 610 is associated with the writing of one or more log entries of log template type A, node 620 is associated with the writing of one or more log entries of log template type B, and node 630 is associated with the writing of one or more log entries of log template type C. Similarly, node 612 is associated with the writing of one or more log entries of log template type D, node 614 is associated with the writing of one or more log entries of log template type E, node 616 is associated with the writing of one or more log entries of log template type F, node 618 is associated with the writing of one or more log entries of log template type G, and node 622 is associated with the writing of one or more log entries of log template type H.

In some embodiments, all of the nodes of FSA 600 illustrated in FIGS. 6A-6F may represent the writing of log entries into a single log file by program instructions in the same application. For example, each of the four paths on the directed graph that begin at node 610 and eventually reach node 620 may correspond to different execution paths of the same application, such as when the program takes different branches following an instruction to write a log entry of log template type A (at node 610) before eventually reaching an instruction to write a log entry of log template type B (at node 620) and then reaching an instruction to write a log entry of log template type C (at node 630). In this example, on each path, one or more additional log entries of respective different log template types are written to the log file between the two instructions that write log entries of log template type A and log template type B, respectively. In other embodiments, each of the four paths on the directed graph that begin at node 610 and eventually reach node 620 may correspond to different applications that are executing in parallel on the same node or on different nodes in the transport network. During operation, program instructions in these applications may write to a central log file or may write to respective local log files that are subsequently aggregated for analysis, pruning, and the identification of repeated patterns, as described herein. In some embodiments, a pruning exercise may be used to detect an invariant in these four paths of FSA 600, such as a repeated pattern of log entries of particular log template types that is always present, with or without any extraneous (e.g., less frequently present and/or irrelevant) log entries between some of the log entries of the repeated pattern.

In FIG. 6A, each edge is labeled with an initial number of transitions between log entries of the log template types associated with the nodes that are connected by the edge on a particular path in the FSA based on an extraction of the log templates from the log file. For example, the label on the edge between node 620 and node 630 may indicate that, for a single path in the FSA (which may correspond to a single execution path of an executing program), there were four instances in which the log file included a log entry of log template type B that was followed directly by a log entry of log template type C and these four instances are represented by one merged edge in the FSA. In this example, because the minimum support threshold value is set to four, a group of log file entries including one log entry of log template type B followed a log entry of log template type C may be identified as a repeated pattern of log entries for the purposes of subsequent performance monitoring and analyses.

In the illustrated example, there are no other single paths on which a direct sequence of nodes is identified as meeting the minimum support threshold value of four. However, through pruning, the identified repeated pattern from node 620 (corresponding to log template type B) to node 630 (corresponding to log template type C) may be extended to include indirect sequences on multiple paths in the FSA that precede or follow the identified repeated pattern and that collectively meet the minimum support threshold value of four. In this example, nodes on multiple paths may be pruned if they have an indegree that is less than the minimum support threshold value of four, as shown by the number of directed edges flowing into the node.

In the example illustrated in FIG. 6A, the indegree of node 620 is four. More specifically, there are four paths in the FSA in which a log entry of log type A (corresponding to node 610) is followed indirectly by a log entry of log template type B (corresponding to node 620). On each of these four paths, there is at least one additional node (corresponding to the writing of a log entry of a log template type other than type A, B, or C) between node 610 and node 620. In this example, the edges between node 610 and node 612 and between node 612 and node 620 indicate that, for the illustrated path from node 610 to node 612 to node 620 to node 630, the log file included only one log entry of log type A that was followed directly by a log entry of log template type D. In this example, the indegree of node 612 is one, which is less than the minimum support threshold value of four. Therefore, as indicated by the dashed border around node 612, this node is identified for pruning and will be removed. Once node 612 is removed, FSA will include an edge directly connecting node 610 to node 620 without going through any intermediate nodes.

FIG. 6B illustrates FSA 600 following the removal of node 612. Here, the FSA includes a dashed edge directly connecting node 610 to node 620 without going through any intermediate nodes. In FIG. 6B, the edges between node 610 and node 614 and between node 614 and node 620 indicate that, for the illustrated path from node 610 to node 614 to node 620 to node 630, the log file included only one log entry of log type A that was followed directly by a log entry of log template type E. In this example, the indegree of node 614 is one, which is less than the minimum support threshold value of four. Therefore, as indicated by the dashed border around node 614, this node is also identified for pruning and will be removed. Once node 614 is removed, there will be a second edge directly connecting node 610 to node 620 without going through any intermediate nodes.

FIG. 6C illustrates FSA 600 following the removal of node 614. Here, the two edges directly connecting node 610 to node 620 without going through any intermediate nodes have been merged into one edge with a value of two, indicating that in two instances, a log entry of log type A (corresponding to node 610) is followed indirectly by a log entry of log template type B (corresponding to node 620). In FIG. 6C, the edges between node 610 and node 622 and between node 622 and node 620 indicate that, for the illustrated path from node 610 to node 622 to node 620 to node 630, the log file included only one log entry of log type A that was followed directly by a log entry of log template type H. In this example, the indegree of node 622 is one, which is less than the minimum support threshold value of four. Therefore, as indicated by the dashed border around node 622, this node is also identified for pruning and will be removed. Once node 622 is removed, there will be a third edge directly connecting node 610 to node 620 without going through any intermediate nodes.

FIG. 6D illustrates FSA 600 following the removal of node 622. Here, the three edges directly connecting node 610 to node 620 without going through any intermediate nodes have been merged into one edge with a value of three, indicating that in three instances, a log entry of log type A (corresponding to node 610) is followed indirectly by a log entry of log template type B (corresponding to node 620). In FIG. 6D, the edges between node 610 and node 616 and between node 616 and node 618 indicate that, for the illustrated path from node 610 to node 616 to node 618 to node 620 to node 630, the log file included only one log entry of log type A that was followed directly by a log entry of log template type F. In this example, the indegree of node 616 is one, which is less than the minimum support threshold value of four. Therefore, as indicated by the dashed border around node 616, this node is also identified for pruning and will be removed. Once node 616 is removed, there will be an edge connected node 610 and node 618.

In FIG. 6E, the edges between node 610 and node 618 and between node 618 and node 620 indicate that, for the illustrated path from node 610 to node 618 to node 620 to node 630, the log file included only one log entry of log type A that was followed directly by a log entry of log template type G. In this example, the indegree of node 618 is one, which is less than the minimum support threshold value of four. Therefore, as indicated by the dashed border around node 618, this node is also identified for pruning and will be removed. Once node 618 is removed, there will be a fourth edge directly connecting node 610 to node 620 without going through any intermediate nodes.

In FIG. 6F, the four edges directly connecting node 610 to node 620 without going through any intermediate nodes have been merged into one edge with a value of four, indicating that in four instances, a log entry of log type A (corresponding to node 610) is followed indirectly by a log entry of log template type B (corresponding to node 620). At this point the pruning of the illustrated portion of FSA 600 is complete. Since the FSA now includes a group of nodes (including node 610, node 620, and node 630) in which the number of edges between each pair of consecutive nodes in the group of nodes meets the minimum support threshold value of four, this group of nodes (labeled as group 625) represents a repeated pattern of log entries for the purposes of subsequent performance monitoring and analyses. In other words, this repeated pattern represents an invariant in the log file corresponding to the normal, observed behavior of the transport network. During subsequent monitoring of the transport network, a log entry of log template type A (as in node 610) should always be directly or indirectly followed by a log entry of log template type B (as in node 620), which should always be directly or indirectly followed by a log entry of log template type C (as in node 630). If a log entry of log template type A is found but it is not followed directly or indirectly by a log entry of log template type B, or if a sequence of log entries of log template types A and B is found but the sequence is not followed directly or indirectly by a log entry of log template type C, this may indicate an anomaly in the transport network, such as a failure of a network element or link, for example. In addition, if the repeated pattern is found in the log file but the timing between the log entries in the repeated pattern is different than the timing between the log entries in the repeated pattern when the repeated pattern was identified, this may indicate an anomaly in the transport network, such as a performance degradation on a network element or link, for example.

FIG. 6F illustrates that a second repeated pattern of log entries may also be identified in the log file using the techniques described herein. In this example, the second repeated pattern is depicted as group 645 including a node 640 (which is associated with the writing of one or more log entries of log template type J) and a node 650 (which is associated with the writing of one or more log entries of log template type K). In this example, as shown by the dashed edge between node 630 and node 640, there is only one path between the two repeated patterns in the log file.

The techniques described herein for automatically and efficiently pruning an FSA created from log templates extracted from a log file and identifying repeated patterns of log entries of particular log template types have been verified using an example dataset in an optical transport network. For this example, certain pieces of network equipment generated a log file referred as a “dip log”. More specifically, on each piece of equipment, or node, multiple programs running on the piece of equipment wrote to a shared log file. In this example, the minimum support threshold value was set to twenty and the pruning exercise identified some single path repeated patterns (which did not require pruning) and some multipath repeated patterns (which were pruned as described above).

In this example, the number log entries was 5113, the number of log template types (and the corresponding initial number of FSA nodes) was 486, and the initial number of edges between various pairs of FSA nodes was 970. Following pruning, the number of FSA nodes was 55 and the number of edges between various pairs of FSA nodes was 118. The number of repeated patterns meeting the minimum support threshold value of twenty found on single paths in the pruned FSA was 61, and the number of repeated patterns meeting the minimum support threshold value of twenty found on multiple paths in the pruned FSA, was 65.

This example demonstrated that the techniques described herein can be used to automatically and efficiently determine both direct and indirect relationships between log entries and to identify frequently repeated patterns of log entries for use in subsequent performance monitoring and analyses for a transport network. The disclosed techniques were found to be much more cost effective than existing frequent pattern discovery algorithms.

In some embodiments, once repeated patterns representing normal behavior in a transport network have been identified, they may be used in performance monitoring and analyses to identify anomalies in the transport network through the detection of deviations from the identified repeated patterns during subsequent operation of the transport network. For example, if a sequence of log entries of particular log template types written into a log file during operation of the transport network includes some, but not all, of the log entries of particular log template types present in an identified repeated pattern or if some of the log entries in a collection of log entries of the log template types in an identified repeated pattern appear in a different order than in the identified repeated pattern, this may indicate that one or more network elements or links between network elements has experienced an error or a failure. In another example, the techniques described herein may be used to detect a loop number anomaly, such as when a user repeatedly attempts to log into a network element in the transport network. In response to detecting a deviation from an identified repeated pattern, a further analysis may be undertaken to identify the anomaly, after which corrective action can be taken to mitigate the identified anomaly. In some embodiments, in response to detecting a deviation from a repeated pattern and/or identifying an anomaly in the transport network associated with the detected deviation, an indication of the deviation or the anomaly may be generated.

In some embodiments, the techniques described herein may be used to compare the behavior of the transport network following a change in the transport network, such as a hardware configuration change at one or more network elements or links, or a software update or patch at one or more network elements or links. For example, if a change occurs in the transport network following the identification of repeated patterns of log entries of particular types in one or more log files written by programs executing in the transport network, the log files written by the programs executing in the transport network subsequent to the change may be monitored and analyzed to determine if there are any deviations from the identified repeated patterns following the change.

In some embodiments, the techniques described herein may be used to compare the behavior of different network elements in the transport network. For example, following the identification of repeated patterns of log entries of particular types in one or more log files written by programs executing on a first network element in the transport network, the log files written by the same (or similar) programs executing on other network elements in the transport network may be monitored and analyzed to determine if there are any deviations from the identified repeated patterns. If so, this may indicate a functional or performance difference between two pieces of equipment in the transport network that should be investigated.

In some embodiments, the techniques described herein may be used to detect a performance degradation at a network element of link based, for example, on the detection of a timing-based anomaly in a log file. For example, based on respective timestamps present in each log entry, a typical, average, median or otherwise expected amount of time between consecutive log entries of particular types in each identified repeated pattern may be calculated and then compared with the amounts of time between the consecutive log entries of particular types in each identified repeated pattern during subsequent operation, or for log files generated on different network elements, to determine whether there is a significant deviation in the timing. Upon detecting such a deviation, further analyses may be performed to determine whether the deviation is indicative of a performance degradation at a network element or link and/or to take corrective action. For example, if the typical, average, or median amount of time between two consecutive log entries of particular types in a given identified repeated pattern was calculated as five seconds, but a subsequently observed amount of time between the two consecutive log entries in the given identified repeated pattern was five minutes, this may trigger a further performance analysis for the transport network.

In some embodiments, the techniques described herein for generating an FSA from log template types extracted from one or more log files in a transport network, pruning the FSA, and identifying repeated patterns of log entries of particular log template types in the log files based on the pruned FSA may be performed during a training phase, after which the writing of log entries to log files in the transport network may be monitored for deviations from the identified repeated patterns. In some embodiments, the training phase may be implemented as an off-line or post-execution analysis of log files previously generated in the transport network, and the results of the training phase may be applied to subsequent performance monitoring and analyses during operation of the transport network that begins at a later time. In other embodiments, the techniques described herein for generating an FSA from log template types extracted from one or more log files in a transport network, pruning the FSA, and identifying repeated patterns of log entries of particular log template types in the log files based on the pruned FSA may be performed during a first portion of time in which the transport network is operating, which may be considered a training phase. In such embodiments, as the operation of the transport network continues, the results of the training phase may be applied to detect deviations from the identified repeated patterns, identify anomalies in the transport network, generate indications of any detected deviations and/or identified anomalies, and/or take corrective actions to mitigate any identified anomalies. In one example, the first few hours of operation of a transport network when initially configured may be considered a training phase during which an FSA is generated from log template types extracted from one or more log files in a transport network, the FSA is pruned, and repeated patterns of log entries of particular log template types are identified in the log files based on the pruned FSA. In some embodiments, additional training phases may be performed periodically or in response to certain conditions (such as following significant changes in equipment types or software versions at network elements or links) to create new baselines of identified repeated patterns for subsequent performance monitoring and analyses.

FIG. 7 is a block diagram of selected elements of an embodiment of a method 700 for using the performance analysis techniques described herein in a transport network. In some embodiments, method 700 may be performed using one or more network elements 102 (see FIGS. 1 and 2). For example, one or more operations of method 700 may be implemented by program instructions in memory media 210 executed by processor 208 or by program instructions in one or more of memory media instances 216 executed by a corresponding processor 214, in different embodiments. In some embodiments, one or more operations of method 700 may be executed by analytics module 316 (see FIG. 3). It is noted that certain operations described in method 700 may be optional or may be rearranged in different embodiments.

In the example embodiment illustrated in FIG. 7, method 700 may begin at 702 by identifying one or more repeated patterns in a log file into which log entries of respective log template types were by the one or more programs executing on network elements in a transport network. In some embodiments, the repeated patterns may be identified using one or more of the operations of the methods illustrated in FIGS. 4 and 5 and described above.

At 704, subsequent to identifying one or more repeated patterns in the log file, the method may include beginning or continuing to monitor log entries written into the log file or into another log file by programs executing in the transport network. For example, in some embodiments, the repeated patterns may be identified in a log file generated during a training phase that takes place while the transport network is in operation, and the method may include continuing to monitor and analyze the log file as additional log entries are added to the log file by programs executing in the transport network following the end of the training phase. In other embodiments, the repeated patterns may be identified in the log file during a training phase that is performed off-line, such as during a post-execution analysis of a previously generated log file, and the method may include beginning to monitor and analyze another log file as log entries are added to the other log file by programs executing in the transport network during subsequent operation of the transport network. In some embodiments, the monitoring and analysis of a log file may be initiated in response to a change in a hardware configuration (e.g., a change in the number or type of network elements or the links between them) or in response to a software change (e.g., a software patch to, or the deployment of a new version of, an application executing in the transport network) to determine whether the change resulted in a deviation from the repeated patterns indicating an anomaly in the transport network. In one example, the repeated patterns may be identified in a log file generated by one or more applications operating on one network element, after which the method may include monitoring and analyzing log files generated by applications operating on one or more other network elements.

If and when, at 706, at least a portion of an identified repeated pattern is detected, the method may proceed to 708. At 708, if a deviation from the identified repeated pattern is detected, the method may proceed to 710. In one example, detecting the deviation from the identified repeated pattern may include detecting, in the log file or in another log file, that one of the log entries of the particular log template types in the repeated pattern is missing in an ordered sequence of log entries that includes other ones of the log entries of the particular log template types in the repeated pattern. In some embodiments, each log entry in the log file includes a respective timestamp indicating the time at which the log entry was written into the log file. In such embodiments, the method may further include determining, based on the respective timestamps of the log entries in the log file, a respective amount of time that elapsed between writing successive ones of the log entries in the ordered sequence into the log file during the training phase. In this example, detecting the deviation from the repeated pattern may include detecting, in the log file or in another log file, that the amount of time that elapsed between writing two successive ones of the log entries in the ordered sequence is different from the respective amount of time between writing the two successive ones of the log entries in the ordered sequence into the log file during the training phase.

At 710, the method may include identifying an anomaly in the transport network based on the detected deviation. For example, the fact that a state is missing in an identified repeated pattern or that the timing between two states in an identified repeated pattern has changed may be indicative of a performance degradation of a network element in the transport network, a performance degradation of a link between network elements in the transport network, an error on a network element in the transport network, an error on a link between network elements in the transport network, a failure of a network element in the transport network, or a failure of a link between network elements in the transport network.

At 712, method 700 may include generating an indication of the identified anomaly and/or taking corrective action to mitigate the identified anomaly. For example, the method may include generating an alert or alarm indicating the detection of the identified anomaly, outputting a signal indicative of the detection of the identified anomaly, or generating a report describing the identified anomaly, in different embodiments. In some embodiments, taking corrective action may include initiating a trap or an interrupt in order to execute an exception or debugging routine, performing a further analysis to determine whether a change in the transport network caused the identified anomaly or to determine whether the identified anomaly represents a functional failure or a performance degradation only, initiating a reversal of a recent hardware configuration or software change, initiating an additional hardware configuration or software change, or disabling a network element or link in the transport network found to have failed or suffered a significant performance degradation, among other possible actions.

In some embodiments, after generating an indication or the identified anomaly and/or taking corrective action to mitigate the identified anomaly, method 700 may return to 704, after which the operations shown as 704-712 may be repeated one or more times (e.g., indefinitely). For example, after taking one or more actions to mitigate the identified anomaly, the method may include restarting or continuing the monitoring and analysis of log entries written into one or more log files by programs executing in the transport network to determine whether the corrective action was successful in mitigating the identified anomaly. In another example, after generating an alert, alarm, signal, or report indicative of the detection of the identified anomaly, the method may include continuing the monitoring and analysis of log entries written into one or more log files by programs executing in the transport network in order to detect any additional deviations from the repeated patterns that may be indicative of further anomalies in the transport network.

As disclosed herein, a rule-based, automated technique for frequent log sequence discovery may inform performance analyses for transport networks. These techniques may include generating an FSA from log template types extracted from one or more log files in a transport network, pruning the FSA, and identifying repeated patterns of log entries of particular log template types in the log files based on the pruned FSA. After identifying the repeated patterns of log entries of particular log template types in the log files, deviations from the identified repeated patterns may be detected and anomalies in the transport network may be identified based on the detected deviations. In some embodiments, indications of any detected deviations and/or identified anomalies may be generated, and corrective actions to mitigate any identified anomalies may be taken. By detecting frequently repeated patterns of log entries of particular log template types and ignoring less frequent patterns of log entries, the disclosed techniques may be more efficient than existing frequent pattern discovery algorithms. In addition, the accuracy of anomaly detection may be improved when compared to a priori type algorithms that are based on analyses of individual log entries.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for analyzing performance in a transport network, comprising:
identifying, in a log file into which log entries are written by one or more programs executing on network elements in the transport network, a plurality of log template types, each log template type including a respective fixed element present in all log entries of the log template type;
creating a data structure representing a finite state automaton in which each node in the data structure represents the writing of one or more log entries of a respective log template type into the log file by the one or more programs, the order of the nodes in the data structure corresponding to the order in which the log entries were written by instructions executed on one or more execution paths of the one or more programs, and in which each edge in the data structure connects nodes representing sequentially written log entries;
pruning the data structure, the pruning including removing nodes for which the indegree is less than a predefined minimum indegree;
identifying, based on the pruned data structure, a repeated pattern in the log file comprising an ordered sequence of two or more log entries of particular log template types, the pattern being repeated at least a predefined number of times in the log file;
detecting, subsequent to identifying the repeated pattern, a deviation from the repeated pattern;
identifying, based on detecting the deviation from the repeated pattern, an anomaly in the transport network.

2. The method of claim 1, wherein detecting the deviation from the repeated pattern comprises detecting, in the log file or in another log file into which log entries are written by programs executing on network elements in the transport network, that one of the two or more log entries of the particular log template types in the repeated pattern is missing in an ordered sequence of log entries that includes other ones of the log entries of the particular log template types in the repeated pattern.

3. The method of claim 1, wherein:
each log entry in the log file includes a respective timestamp indicating a time at which the log entry was written into the log file;
the method further includes determining, based on the respective timestamps of the log entries in the log file, a respective amount of time that elapsed between writing successive ones of the log entries in the ordered sequence into the log file when the pattern was written into the log file at least the predefined number of times; and
detecting the deviation from the repeated pattern comprises detecting, in the log file or in another log file into which log entries are written by programs executing on network elements in the transport network subsequent to identifying the repeated pattern, that an amount of time that elapsed between writing two successive ones of the log entries in the ordered sequence into the log file or the other log file is different from the respective amount of time between writing the two successive ones of the log entries in the ordered sequence into the log file when the pattern was written into the log file at least the predefined number of times.

4. The method of claim 1, further comprising generating an indication of the identified anomaly in the transport network.

5. The method of claim 1, further comprising taking corrective action to mitigate the identified anomaly in the transport network.

6. The method of claim 1, wherein the identified anomaly in the transport network comprises a performance degradation of a network element in the transport network, a performance degradation of a link between network elements in the transport network, an error on a network element in the transport network, an error on a link between network elements in the transport network, a failure of a network element in the transport network, or a failure of a link between network elements in the transport network.

7. The method of claim 1, wherein the pruning further comprises:
identifying multiple paths between nodes in the data structure representing the writing of log entries of a first log template type and nodes in the data structure representing the writing of log entries of a second log template type, each of the multiple paths corresponding to a respective execution path of the one or more programs; and
calculating a frequency of transitions, in the identified multiple paths, from nodes in the data structure representing the writing of log entries of the first log template type and nodes in the data structure representing the writing of log entries of the second log template type.

8. The method of claim 7, wherein identifying, based on the pruned data structure, the repeated pattern in the log file comprises identifying a group of sequentially ordered nodes for which the calculated frequency of transitions between each pair of nodes in the group of sequentially ordered nodes exceeds a predefined minimum number of transitions.

9. The method of claim 1, wherein the log file comprises log entries written into the log file by two or more programs executing on network elements in the transport network, log entries written into the log file by multiple execution paths of a single program executing on a network element in the transport network, or log entries written into the log file by a single program executing on a network element in the transport network.

10. The method of claim 1, wherein for each log template type, the respective fixed element present in all log entries of the log template type comprises an identifier of a hardware or software entity on whose behalf the log entry was written into the log file.

11. A system comprising a processor configured to access non-transitory computer readable memory media storing instructions executable by the processor for:
identifying, in a log file into which log entries are written by one or more programs executing on network elements in the transport network, a plurality of log template types, each log template type including a respective fixed element present in all log entries of the log template type;
creating a data structure representing a finite state automaton in which each node in the data structure represents the writing of one or more log entries of a respective log template type into the log file by the one or more programs, the order of the nodes in the data structure corresponding to the order in which the log entries were written by instructions executed on one or more execution paths of the one or more programs, and in which each edge in the data structure connects nodes representing sequentially written log entries;
pruning the data structure, the pruning including removing nodes for which the indegree is less than a predefined minimum indegree;
identifying, based on the pruned data structure, a repeated pattern in the log file comprising an ordered sequence of two or more log entries of particular log template types, the pattern being repeated at least a predefined number of times in the log file;
detecting, subsequent to identifying the repeated pattern, a deviation from the repeated pattern;
identifying, based on detecting the deviation from the repeated pattern, an anomaly in the transport network.

12. The system of claim 11, wherein detecting the deviation from the repeated pattern comprises detecting, in the log file or in another log file into which log entries are written by programs executing on network elements in the transport network, that one of the two or more log entries of the particular log template types in the repeated pattern is missing in an ordered sequence of log entries that includes other ones of the log entries of the particular log template types in the repeated pattern.

13. The system of claim 11, wherein:
each log entry in the log file includes a respective timestamp indicating a time at which the log entry was written into the log file;
the non-transitory computer readable memory media further stores instructions executable by the processor for determining, based on the respective timestamps of the log entries in the log file, a respective amount of time that elapsed between writing successive ones of the log entries in the ordered sequence into the log file when the pattern was written into the log file at least the predefined number of times; and
detecting the deviation from the repeated pattern comprises detecting, in the log file or in another log file into which log entries are written by programs executing on network elements in the transport network subsequent to identifying the repeated pattern, that an amount of time that elapsed between writing two successive ones of the log entries in the ordered sequence into the log file or the other log file is different from the respective amount of time between writing the two successive ones of the log entries in the ordered sequence into the log file when the pattern was written into the log file at least the predefined number of times.

14. The system of claim 11, wherein the non-transitory computer readable memory media further stores instructions executable by the processor for generating an indication of the identified anomaly in the transport network.

15. The system of claim 11, wherein the non-transitory computer readable memory media further stores instructions executable by the processor for taking corrective action to mitigate the identified anomaly in in the transport network.

16. The system of claim 11, wherein the identified anomaly in the transport network comprises a performance degradation of a network element in the transport network, a performance degradation of a link between network elements in the transport network, an error on a network element in the transport network, an error on a link between network elements in the transport network, a failure of a network element in the transport network, or a failure of a link between network elements in the transport network.

17. The system of claim 11, wherein the pruning further comprises:
identifying multiple paths between nodes in the data structure representing the writing of log entries of a first log template type and nodes in the data structure representing the writing of log entries of a second log template type, each of the multiple paths corresponding to a respective execution path of the one or more programs; and
calculating a frequency of transitions, in the identified multiple paths, from nodes in the data structure representing the writing of log entries of the first log template type and nodes in the data structure representing the writing of log entries of the second log template type.

18. The system of claim 17, wherein identifying, based on the pruned data structure, the repeated pattern in the log file comprises identifying a group of sequentially ordered nodes for which the calculated frequency of transitions between each pair of nodes in the group of sequentially ordered nodes exceeds a predefined minimum number of transitions.

19. The system of claim 11, wherein the log file comprises log entries written into the log file by two or more programs executing on network elements in the transport network, log entries written into the log file by multiple execution paths of a single program executing on a network element in the transport network, or log entries written into the log file by a single program executing on a network element in the transport network.

20. The system of claim 11, wherein for each log template type, the respective fixed element present in all log entries of the log template type comprises an identifier of a hardware or software entity on whose behalf the log entry was written into the log file.
